(19) United States
(12) Patent Application Publication
(10) Pub. No.: US 2017/0058441 A1
(43) Pub. Date: Mar. 2, 2017

(54) AN APPARATUS FOR FORMING OF CONSOLIDATION REGIONS IN A WEB

(71) Applicant: Concepts for Success, Euskirchen (DE)

(72) Inventor: Christoph Schmitz, Euskirchen (DE)

(73) Assignee: Concepts for Success, Euskirchen (DE)

(21) Appl. No.: 15/308,077

(22) PCT Filed: Apr. 29, 2015
(86) PCT No.: PCT/EP2015/059269

§ 371 Date: Oct. 31, 2016

(30) Foreign Application Priority Data
Apr. 29, 2014 (GB) 1407547.7

(51) Int. Cl. D04H 1/54; B29C 65/00; B29C 65/08; D04H 1/542; D04H 1/555

(52) U.S. Cl. CPC D04H 1/54; D04H 1/542; D04H 1/555; B29C 65/087; B29C 66/73921; B29L 2031/48

(57) ABSTRACT

The present invention relates to an apparatus for thermally treating webs which comprise thermoplastic respectively meltable compounds, thereby creating cylindrical or elliptic consolidation regions which may optionally comprise an aperture by employing a thermal energy source, such as ultrasonic energy, as well as to webs comprising elliptic consolidation regions. In a particular aspect the invention concerns apparatus and methods for creating the consolidation regions by using an anvil with a contact member that is supported by support ribs in its outer or proximal portion.

### FIELD OF THE INVENTION

The present invention relates to an apparatus for thermally treating webs which comprise thermoplastic respectively meltable compounds, by creating consolidation regions which may optionally comprise an aperture, by employing a thermal energy source, such as ultrasonic energy, as well as to webs comprising consolidation regions. In a particular aspect, the invention concerns an apparatus for creating the elliptic consolidation regions which comprises contact member which are supported in their outwardly positioned portions.

### BACKGROUND

Treating webs which comprise meltable components with thermal energy is well known in the art, both for bonding such webs and/or creating apertures in such webs, such as by running webs through a nip of two rolls, one or both of which may be heated and/or embossed. This principle can be applied to consolidating webs as such, such as non-woven webs, or by connecting webs to each other, such as creating a seam-like bond.

For example, businesses in the textile and personal products industries often manufacture articles such as diapers, clothing, etc., that are ultrasonically welded.

U.S. Pat. No. 6,457,626 (Branson) describes the use of a rotary anvil and a rotary horn comprising two symmetrical halves, for ultrasonic welding of diapers, clothing in textile and personal products industries and film sealing industries. U.S. Pat. No. 6,517,651 (Tefron) describes a stationary ultrasonic horn cooperating with a rotating anvil. U.S. Pat. No. 65,187,650 (Kimberly-Clark) pertains to apparatus and methods for intermittently creating ultrasonic bonds in sequentially advancing work piece segments in a nip. The apparatus is designed sufficiently rigid, that the ultrasonic horn and the anvil can be brought together with low interference levels.

In EP1144187A1 a process is described, wherein circular protrusion on a bonding roll create circular bond points exhibiting a particular three-dimensional cross-section. However, the construction of such a roll as well as its operation is difficult and the circular bond points do not allow for directional property differences in the material.

In WO2008/129138 individual bonding points are shown having the shape of oval perimeter aligned in machine respectively cross-machine direction.. According to the description it improves the abrasion resistance without compromising softness and drapeability. WO99/014415 discloses a bonding pattern for a web showing oval bonding points arranged in a skewed angle relative to the machine direction. In WO09/021473 (PEGAS) a bonding pattern is described with machine directionally extending bonding points. On the bonding roll, the bonding point protrusions have an oval shape and a trapezoidal cross-section. In U.S. Pat. No. 6,713,159 (K—C) a seaming pattern comprising oval bonding points is described.

U.S. Pat. No. 6,220,490 (K—C) discloses a seaming pattern with at least two sub-patterns for specific distribution of stress forces across the seam. In U.S. Pat. No. 5,620,779 relating to creating ribboned non-woven, bonding patterns are described which comprise ovals and/or ellipses as well as skewing of bonding pattern relative to the machine direction.

It is also known to employ ultrasonics for the creation of apertures in web materials, such as described in U.S. Pat. No. 3,949,127 or U.S. Pat. No. 3,966,519, relating to nonwoven materials, or U.S. Pat. No. 3,756,880 relating to films.

In U.S. Pat. No. 1,328,890, a method and an apparatus is described for perforating a material, wherein a sharp open ended pin, protrudes and retracts by being biased by a spring coil against a cam to operate against an ultrasonic horn. In DE10112185, an anvil for an ultrasonic system is described, wherein a cylindrical shell is mounted concentrically on an anvil core and the two parts are separated by one or more elastic elements. On its outer surface, the shell comprises engraved protrusions that contact the ultrasonically treated web. In GB2278312, a system is disclosed, wherein a spherical anvil element is pushed against a an ultrasonic horn by means of a resilient hose with pressurized air.

In the co-assigned WO2012/042055 (the “WO'055 application”) (a method and an apparatus are disclosed for forming consolidation regions in a web by thermally treating webs which comprise thermoplastic respectively meltable compounds, thereby creating cylindrical or elliptic consolidation regions which may optionally comprise an aperture by employing a thermal energy source, such as ultrasonic energy, in particular by using an anvil with a flexible elongated member, such as a wire, a chain or a tubular anvil with circumferential ribs, such as flexible helical springs.

However, it has been found that the apparatus as described therein can lead to variable quality of the bonding, if the flexible elongated member exhibit too high dimensional variability, in particular concerning the runout, as may result from variations of the wire thickness that form the helical anvil elements, or from variations of the helical winding of the wires. Further, for certain applications requiring a relatively high pressure in the gap for creating the consolidation regions, the overall flexibility of the flexible anvil created large deformation of the flexible anvils.

Henceforth, it is an objective of the present invention to provide an apparatus that widens the range of useful materials and more robustly ensures consistent consolidation point properties.

### SUMMARY

The present invention is an apparatus for consolidating one or more region(s) of one or more web(s), which comprise(s) thermoplastic material and which exhibit a length (x-), width (y-) and thickness (z-) direction, by plastic deformation. The apparatus exhibits a x- or machine direction aligned with the direction of movement of the web(s) relative to the apparatus, a y- or cross-machine direction aligned with the width direction of the web(s). The apparatus comprises
one or more energy source(s) for increasing the temperature at least of the region(s) of the web(s);
a first and a second anvil forming a gap and adapted to receive the web(s) therein such that the thickness or z-direction of the webs is aligned with the gap width; and
a gap width adjustment means adapted to apply pressure to the web(s) in the gap.

Therein, the first anvil is rotatably mounted around a cross-machine direction oriented first anvil axis, further exhibiting a radial r-orientation away from the first anvil axis. The first anvil comprises
a first anvil core having its axis aligned with the first anvil axis;
at least one first anvil support rib, extending from the first anvil core r-directionally outwardly as well as preferably predominantly circumferentially,

at least one contact member for contacting the webs in the gap.

The contact member comprises a rounded outward portion, that is positioned radially outwardly of the first anvil support rib and that is extending into the gap and is adapted for a r-directional dislocation upon the application of a pressure by the gap width adjustment means. The contact member further comprises at least one further portion extending radially downwardly towards the first anvil axis. The contact member exhibits one or more centre lines that are arranged such that they are generally oriented circumferentially on the surface of the first anvil and do not coincide with the first anvil's axis.

The r-directional dislocation of the outward portion of the contact member may be achieved by means selected from the group consisting of.

a) two support points at the distal ends of the support ribs, over which the rounded outward portion of the contact member arches;

b) the contact means being supported by the further portions whilst the outward portions are adapted to not be in direct contact with the support ribs when no pressure is applied by the gap adjustment means, but to contact the support ribs when pressure is applied by the gap adjustment means;

c) a damper element positioned between the support rib and the contact member or the anvil core;

d) the support ribs exhibiting damper element properties.

The contact member of the first anvil may preferably be selected from the group consisting of a wire, a helical spring preferably exhibiting a is circular, elliptical, flattened spherical, or hexagonal cross-section, a litz wire, a rounded ring, preferably a circular, elliptical, oval ring, split rings, an open ring, a C-ring, an E-Ring, and a half ring.

Preferably, the rounded outward portions exhibit a runout of less than 2 mm, preferably less than 0.2 mm, more preferably less than 20 μm.

Preferably, the energy source is ultrasonic energy provided by the second anvil, optionally a rotatable mounted sonotrode.

The apparatus may be employed to consolidate a web by the following method step: providing an apparatus according to any of the preceding claims;
a) providing at least one web comprising thermoplastic material, the web exhibiting a x- or machine direction, a y- or cross-machine direction, and a z- or thickness direction;
b) forming a gap corresponding to the z-direction of the web(s) between the first anvil and the second anvil,
c) feeding the web to the gap;
d) applying a z-directional pressure to the web in the gap, corresponding to a r-directional pressure applied to the contact member of the first anvil, thereby allowing dislocating the rounded outwardly oriented surface of the contact member of the first anvil;
e) optionally providing energy to induce a temperature increase in the web or in predetermined regions thereof;
f) compressing the web(s) in a predetermined pattern in the gap, thusly creating the consolidation regions; wherein the outwardly oriented surface of the contact member of the first anvil is radially dislocated more than 1 μm, preferably more than 0.1 mm, more preferably more than 0.3 mm, relative to the first anvil axis.

### BRIEF DESCRIPTION OF THE FIGURES

FIGS. 1A and 1B schematically depict a first anvil according to the present invention.

FIGS. 2A and 2B depict schematically another execution of the first anvil according to the present invention.

FIGS. 3A and 3B depict schematically an even further execution for the present invention.

FIG. 4 depicts yet a further execution according to the present invention.

FIG. 5 depicts schematically an apparatus according to the present invention.

Same numerals depict corresponding elements or features in all figures.

### DETAILED DESCRIPTION

The present invention relates to an apparatus for the consolidation of one or more web(s). It should be noted that the present description covers various execution of various features and elements, which, however, are not necessarily limited to the context in which they are described.

Within the present context, the term “web” or “web material” refers to materials, which—when employing Cartesian coordinates—exhibits a general longitudinal or x-directional extension, which may be and often is the direction of the material on a roll. In this direction, the web is essentially endless, or at least significantly longer than in its width or y-direction perpendicular thereto. The web has a thickness z, typically much smaller than either of the x- or y-direction. Web materials may be essentially solid materials, such as in the case of film or foils, or may have porous regions and be readily compressible, such as in the case of fibre containing materials, or foams, or when films are three-dimensionally formed. A web may be a combination or a composite of several materials, such as when two or more layers of material are combined. The layers may be other webs, or may be material pieces, such as may be cut pieces from other webs.

When a web comprises fibrous materials, these may be bonded webs, such as nonwoven webs, or may be batts, such as an unbonded accumulation of fibres, or may be an accumulation of several strata of fibrous material. Such batts may also comprise a certain amount of bonding between the fibres. Webs may be bonded or pre-bonded by any conventional technique, such as by heat- or melt-bonding, which may be created through compression and/or application of pressure, heat, ultrasonic, or heating energy, cohesion, adhesion, such as by glue or adhesive application. Nonwoven webs can be formed by many processes including—without limitation—meltblowing, spunbonding, spunmelting, solvent spinning, electro-spinning, carding, film fibrillation, melt-film fibrillation, airlaying, dry-laying, wetlaying with staple fibers, and combinations of these processes as known in the art.

When the web comprises films, this refers to essentially continuous layers or strata of skin- or membrane-like material, though such films may also comprise apertures, or may actually form a net-like structure.

The present invention relates to an apparatus for consolidating a web which comprises thermoplastic material, i.e. meltable or at least softenable materials or compounds, which have a melting temperature higher than an ambient temperature of 25° C., but typically less than about 300° C. Typical materials may be—without limitation—polyolefins such as polyethylene or polypropylene.

Such webs may further comprise other materials, such as particulate material, or fluids applied thereto, as long as the web-structure is not compromised. The web may comprise further materials, which are not thermoplastic, i.e. non-meltable, such as without limitation cellulosic fibres, or which melt at higher temperatures. The amount of meltable material will determine the properties of the resulting web, and for most applications, the web will comprise at least 10%, often more than 50% or even more than 90% of the meltable components.

A web can be a single layer web, e.g. when a pattern is introduced thereto. A web can be a single folded web, e.g. when edges are overfolded and seamed. A web can be made up of several individual webs or strata which are to be connected according to a preset linear or two dimensional pattern.

A web typically exhibits certain variations of its properties along its machine and cross-machine direction. A lot of effort is often spent against homogenizing such variation, such as by overlaying several sub-strata. However, important properties, in particular basis weight, density, calliper, and in the case of fibrous materials fibre diameter, fibre distribution (homogeneity) fibre length etc. still vary to a certain degree, and thus often provide difficulties in the further processing of such a web, in particular when such a web is combined with other materials, such as by fusion bonding. Typical issues are incomplete consolidation or “burn through”, i.e. an undesired hole is formed in the bonding region.

In view of the present discussion, it should be noted, that the term “variability” refers to parametric values of the respective property as determined by any appropriate measurement method with a resolution that allows differentiation between the consolidation points and the circumscribing regions of the web. Express reference is made to the 2011 edition of the Standard Test Methods for the Nonwovens Industry issued by EDANA, Brussels, Belgium. Within the present discussion, a web comprises one or more consolidation region(s). A consolidation region is a web region which was subjected to a thermal and/or mechanical treatment, whereby at least a portion of the web material is softened or melted and subsequently or simultaneously compressed so as to create a plastic deformation of the material. A typical example well known to a skilled person is a thermoplastic fibrous material, which is bonded to become a bonded non-woven material by introducing consolidation regions, often also referred to as bonding points, such as may be achieved by running the unbonded batt though a nip between two heated rolls, at least one of which has bonding protrusions, which will create a corresponding bonding pattern in the web. Another typical example is the seaming of two materials, such as well known in the making of disposable articles, where two webs, such as a non-woven web and a plastic film, are bonded to each other such as by applying pressure and/or thermal energy.

With regard to forming consolidation regions, express reference is made to the above mentioned WO'055 application. In the consolidation regions, the thermoplastic meltable material is molten or at least sufficiently softened so as to allow plastic deformation. In this consolidation region, the web material is compressed so as to exhibit a smaller calliper or thickness than the surrounding region. If the web essentially consists already of solid molten material, such as may be the case with film material, also these may be compressed, such as in the case of embossed films or in the case of two films being bonded together. Otherwise, a small amount of the film material may be squeezed laterally outwardly. Around a centre region of the consolidation region, where this plastic deformation and reduction of calliper or thickness occurred, the consolidation region comprises a transition region, as a transition from the centre region to the surrounding region of the web, which is not being consolidated the same way as the consolidation region. In this transition region, the thickness/calliper of the web increases from the centre region to the surrounding region, whilst the local density decreases accordingly. Some of the molten or plastically deformed material may be squeezed from the central region into the transition region.

The consolidation region exhibits a certain geometric extension, both with regard to the x-y-dimensions of the web, as can be seen in a x-y-top view of the web and to the z-directional dimension, as can for example be seen in a cross-sectional cut along the thickness direction of the web.

Preferably, the consolidation regions resulting from employing the apparatus according to the present invention exhibit a generally non-circular elliptical shape in their top view and that also the x-z- or y-z-oriented cross-section through a consolidation point exhibits at least partially elliptically shaped boundaries. The latter corresponds to an ellipsoidal or frusto-ellipsoidal indentation in at least one surface of the bonding region, which may be formed of the centre region and the transition region. The smooth transition from the consolidation region to the surrounding regions provides a particular balance of tactile properties and strength. The major or longer axis of the ellipse may be aligned with any major direction of the web, though in a particular embodiment the axis may be at an angle of more than 0° and less than 45° to the machine directional axis of a web. Within the present context, the term “frusto-ellipsoidal” refers to a shape of a truncated ellipsoid, i.e. an ellipsoid of which a part is cut away by a plane. Whilst geometrically strictly speaking also circles represent a special form of an ellipse, they are not considered within the present scope, as these will not provide particular benefits as will be discussed in more detail herein below. Thus the term ellipse should be read as non-circular ellipse.

For certain execution and as will be described herein below, the consolidation regions may also exhibit a cylindrical or oval indentation with an essentially rectangular shape in their top view, optionally with rounded edges. It should be noted, that in a preferred execution this cylindrical shape corresponds to a right circular cylinder, though non-circular, non-right-angled, and even cylinders with a apex (i.e. having a frusto-conical shape) are considered to fall within the scope of the term cylinder. In this execution and in contrast to the previous execution the smooth transition from the consolidation region to the surrounding regions is effective only in the radial direction. For certain applications, this may provide an even wider range of balancing properties.

Typically, though not necessarily, several consolidation regions form one or several readily recognizable repeating linear or two-dimensional pattern(s). Therein a row of regions is a group of regions that are arranged predominantly along the cross-direction, whilst in a column the group of regions is arranged predominantly along the machine direction. Within the present description and in the context of directions or orientations, “predominantly” refers to the situation, that the projection of a characteristic line onto one direction is larger than onto the other direction perpendicular thereto. There may be more than one pattern simultaneously in one web, which may be intermittent, overlaying, inter-digitizing. Such patterns may be formed simultaneously, and thus typically are in a specific registry to each other. Such patterns may also be formed independently of each other and then often have no direct correlation to each other, such as when a web already having a bonding pattern is submitted to a process according to the present invention, or if a web is treated twice in subsequent process steps according to the present invention.

In a first alternative, the molten material is partly removed from the consolidation region, such that effectively a predetermined weakening of the web or even a hole or an aperture can be achieved. In contrast to the above mentioned “burn through”, this aperturing can be achieved in a very reproducible manner, such as when a predetermined aperture size is desired. The aperture may also be an essentially endless one, such as for separation of the web.

In a second alternative, the molten material remains in the consolidation region, which is then often referred to as a “bond point” or “bonding region”. Such a bond point may be used for bonding or consolidating components of such a web, such as when the untreated web or batt comprises loose fibres. Also, bonding may be performed between strata or layers of one or more webs, such as when spun-laid or melt blown layers are positioned on each other, bonding can be achieved across all or some of these layers or strata. Similarly, bonding may be achieved between two or more webs, which may differ in at least one property such as a film and a fibrous web. Further, employing the apparatus according to the present invention may create an aperture in one of the layers but a bond point in one or preferably two enveloping webs.

In particular for the bonding of fibre containing webs, employing the apparatus according to the present invention provides improved tactile softness. Without wishing to be bound by the theory, it is believed, that this improvement results from the gradual transition of a fibrous structure around the consolidation regions to the molten centre of the regions.

The apparatus may very favourably be employed for the bonding of webs when there are non-meltable materials between the webs, such as described in co-pending and co-assigned WO2014/001487 or WO2014/001488 publications, to which express reference is made for this aspect.

As further detailed in the above referenced WO'055 application, the consolidation regions are formed by passing the web(s) through a gap, formed by a first and a second anvil, such as without limitation—the nip between two essentially cylindrical rolls.

Often, the gap is described to be between a tool and a counteracting anvil, indicating that on one side of the gap a certain action is performed, whist the other side of the gap is passive. Within the present context, such a distinction does not appear appropriate, and henceforth either side of the gap is referred to as an “anvil”. Within the present context, the first anvil comprises at least a first anvil core, support rib, and contact member, as will be discussed in more detail. The second anvil may be stationary, or a rotating cylindrical counter roll having a roll axis aligned with the cross-machine direction of the process and the web such as for providing energy. Conventional thermo-bonding equipment often comprises a smooth anvil roll and a patterned embossing roll. The pattern is created by protrusions on the surface of the embossing roll. Typically, such protrusions exhibit a frusto conical or frusto-pyramidal shape, or a trapezoidal cross-section.

The second anvil may be heated, or may comprise energy emitting elements, such as ultrasonic devices. Accordingly, also the first anvil may have heated elements, or may have (in addition to having the flexible tubular anvil element) protrusions.

The gap has a gap width, which extends in the z-direction of the web, and which is the narrowest distance between the anvils in the gap. Thus, if a gap is formed between a smooth and an embossed roll with protrusions, the gap width is the distance between the top of the protrusions and the smooth roll. If the protrusions have a rounded surface, the gap width is between the top of the curvature, which is oriented towards the smooth roll, and the smooth roll. The gap width impacts the compression in the consolidation regions, such that upon reduction of the gap width apertures may be formed therein. The gap width together with the height of the protrusions also determines, if a web run through the gap is not compressed, or only compressed to a certain degree outside of the consolidation regions. If one or both of the anvils have a round shape, such as when cylindrical rolls are used, the gap extends along a cross-directionally oriented line, defining the gap region.

In order to create consolidation regions, energy is applied to the web. A thermal energy source may be any heat source as well known in the art for thermo-fusing web materials. It is also contemplated, that the energy is provided by several means. For example, the web may be pre-heated to a temperature close to the plasticizing or melt-temperature before it is run through a nip, where by mechanical deformation energy through the pressurizing in the nip and/or additional thermal energy—such as by heated protrusions—the material is plasticized or molten, such that upon compression consolidation regions are formed.

In a preferred execution, an energy source in the second anvil creates sonic, more preferably ultrasonic waves. Ultrasonic welding tools operate under the principle of applying acoustic energy in the ultrasonic frequency range (i.e., typically at or above 20 kHz) to a horn. The horn or sonotrode vibrates in response to the applied acoustic energy to further produce an output acoustic energy. The output acoustic energy is applied to the thermo-fusible web materials which are positioned between the sonotrode and a counteracting support, respectively anvil. The vibration energy travels through the web, and is converted to heat. Without wishing to be bound by the theory, it is believed that the conversion is due to intermolecular friction that melts and fuses the thermo-fusible material such that it can be fused by compression.

The thermal energy source is preferably positioned stationary relative to the moving web and anvil, but it may also be rotatably mounted and optionally also translatorily moveable. Preferably the one or more thermal energy source(s) are designed sufficiently wide to cover the full y-directional extension of the bonding curve or bonding area to avoid or minimize y-directional movement of the energy source.

The anvil or anvils comprise surface elements forming the gap and form the consolidation regions in the web. The anvil or the anvils may further comprises means for maintaining the positioning of webs hereon, such as vacuum suction means. The apparatus may comprise elements for treating the webs prior to the application of energy, such as embossing or calendering.

These consolidation regions will then “imprint” the surface elements into the web. Thus, a pattern of the anvils can be seen as a pattern in the treated web. However, the pattern will not be mirrored exactly in a one to one relationship. The relative positioning of centre points of protrusions may be about the same as of the centre points of the consolidation regions, depending e.g. on longitudinal and cross directional extension of the web, but the size of the consolidation regions may differ from the size of the protrusion. The difference in size is primarily depending on the shape and form of the protrusions cooperatively with the gap width, gap pressure, and material calliper.

Thus, if the protrusions were cylindrical and had a rectangular cross-sectional shape along the surface of their support, the centre region of the consolidation regions should have for a sufficiently small protrusion depth the same size and shape as the protrusions. As commercially used bonding tools typically comprise protrusions that exhibit a trapezoidal cross-sectional shape when viewed along the surface of their support, this will for example result for a greater penetration depth or smaller gap width and a given material in a larger consolidation region, as even if the centre region of the consolidation region remains the same, more material will be squeezed into the transition region which will thusly be enlarged. However, the sharp angle between protrusion top and side surface will create a small transition region with a sharp change in properties, where fibres and/or fibre anchoring may be damaged, thusly resulting in reduced strength of such conventional webs.

Further, for a given protrusion shape the gap width or gap pressure will impact the penetration depth of the protrusions into the web, and the molten material will be squeezed to a different degree laterally outwardly into the surrounding, depending on the calliper of the material. Thus, the centre region of the consolidation region may correspond to the protrusions, but typically will be somewhat larger by having some of the molten or plastically deformed material into the transition region.

These effects are much less pronounced in the technology employed in the present invention: As the outward portion of a contact member, i.e. the portion that extends into the gap,slopes away from the apex or the “highest” contact point in all directions in case of the elliptical indentations, there is effectively not one penetration depth, but the cylindrical or elliptical indentations as described will result. Because of the sloping of the protrusion molten material is displaced from the deepest impression point in the centre of the centre region towards the less deep impressed regions of the centre region and possibly into the transition region. Thus a much more gradual transition will result with less fibre damage and henceforth improved strength, whilst having a much smoother boundary and hence improved tactile softness.

As described in the above, any web material exhibits certain variability with regards to certain important web properties, such as basis weight, density, or calliper (which may be interdependent), but also fibre diameter, fibre distribution etc in case of fibre containing webs or pore size and lamellae properties in case of foams. Thus when such webs are run though conventional processes such as thermo-bonding or ultra-sonic bonding, the process is susceptible to such variability, and an unstable process may provide unacceptable variability in material properties, such as incomplete melting, “burn through” etc, all well known to a skilled person. Accordingly, significant effort has been spent for conventional stiff and rigid systems against adjusting the gap width according to such variability, such as described for the case of applying ultra-sonic energy to a web, e.g., as described in EP0920977A1 (Herrmann).

In contrast thereto, the technology as described in the hereinabove mentioned WO'055application as well as employed in the present invention exploits the flexibility of the anvil elements. In this, the present invention relates to an apparatus for creating one or more consolidation region(s) by plastic deformation in one or more webs, which comprise(s) thermoplastic material. The apparatus exhibits a x- or machine direction aligned with the direction of movement of said web(s) relative to the apparatus, a y- or cross-machine direction aligned with the width direction of the web(s). The apparatus comprises one or more energy source(s) for increasing the temperature at least of predetermined regions of said web(s). This temperature increase may be for the whole of the web, such as when the web is pre-heated, such by being run through an oven, or over heated rolls, or by radiation, or by hot air forced through the web. Preferably, the heating is not limited to the heating of the surface, but the temperature is increased homogeneously throughout the web.

The temperature increase may also be for predetermined regions only, such as when protrusions of a heated roll contact the web. The energy source may also be integral with the compression unit, such as when mechanical energy is transformed into thermal energy.

The apparatus comprises a first and a second anvil, forming a z-directionally oriented gap exhibiting a gap width aligned with the z-(thickness) direction of the web(s). In the gap, pressure may be applied to the web by conventional gap width adjustment. The first anvil as used in the apparatus according to the present invention is rotatably mounted around a cross-machine direction oriented first anvil axis, further exhibiting a radial r-orientation away from said first anvil axis. The first anvil comprises a first anvil core of cylindrical shape having its axis aligned with said first anvil axis, at least one first anvil support rib, extending from said first anvil core r-directionally outwardly as well as preferably predominantly circumferentially, and at least one contact member for contacting said webs in said gap. The first anvil cooperates with a counteracting second anvil.

The contact member may be executed such that each one contact member comprises an outward portion that is intended to be in contact with the web for forming a consolidation region. Alternatively, each of one or more contact members may have multiple outward portions that are intended to be in contact with the web for forming a consolidation region. The contact member may be executed as an “elongated member”, which has an x-directional extension which is larger than the average of the shortest and longest main cross-sectional distances (e.g. diameter). It is, however, contemplated, that also relatively short members may be employed as contact member. In order to achieve the preferred non-circular shape of the consolidation regions, as described in the above, it is preferred that the outward portion of the contact member extending into the gap does not exhibit a spherical shape.

In a particularly preferred execution a contact member is executed as an elongated member comprising one or more outward portions, or a plurality of short members each having essentially only one outward portion that is positioned on the surface of the first anvil in a generally circumferential orientation. If the contact member is executed as elongated member this can be described by connecting the geometric centre points of cross-sections of the contact member essentially perpendicular to the general direction of the elongation to form a contact member centre line. If short members or members having a single outward portion are employed, a plurality of such members are positioned relative to each other such that the geometric centre points of each of the members form a contact member centre line. The one or more contact member centre lines are most preferably arranged such that they are generally oriented circumferentially on the surface of the first anvil and do not coincide with the first anvil's axis.The term “flexibility” refers to a property of an elongated member, which also may be referred to as flexural strength, and as such may be determined by methods known to a skilled person. Within the present context, the flexibility is determined by the flexibility test method.

In order to execute the flexibility test, the elongated member is firmly fixed (e.g., clamped) horizontally such that at least 5 cm protrude freely outwardly. At 5 cm distance from the fixation, a weight of 1 kg is applied and the vertical deflection is measured. It may occur, that the flexible member is so flexible, that it satisfies the deflection criterion without any or with a lower weight. If the elongated member is applied in the apparatus in a tensioned state (e.g., a tensioned spring), it should be measured in a relaxed condition. If the elongated member is of a chain type, the chain elements are typically very stiff and the flexibility of the chain is dominated by the flexibility of the pivoting joints.

A material is considered to be flexible, when it passes the flexibility test by exhibiting a vertical deflection in the test of more than 0.01 mm. Preferably, the material deflects more than 0.1 mm, more preferably more than 0.3 mm, and further suitable materials may exhibit a value of more than 1 mm or more than even 1 cm. It should be noted, that the flexibility test requires the deflection criterion to be satisfied in two directions perpendicular to each other and to the elongation axis of the member. The skilled person will readily realize, that other test methods such as ISO 12135 (Metallic materials. Unified method for the determination of quasi-static fracture toughness), ASTM D790 (Standard test methods for flexural properties of unreinforced and reinforced plastics and electrical insulating materials), ISO 178: Plastics—Determination of flexural properties) aim for determining essentially the same property, and thus may be employed equivalently, if the correlation is ascertained.

At least a region of the contact member can be radially dislocated by application of a radially applied force. Thus when a gap width adjusting means applies a force towards in the direction of the first anvil axis, this region moves reversibly relative this axis. Reversibly refers to the fact that upon removal of the force, this region returns to its original position. This can be achieved by structural elements, as will be discussed in more detail herein below, but will require certain flexibility or deformability properties of the element, which should be more than the flexibility or deformability at least of the first anvil core. This is in contrast to conventional heated calender roll but also rigid ultrasonic equipment, both with essentially undeformable anvils and complicated measures are taken to adjust the gap width upon material variability and/or process variability, such as temperature increases during operation. The contact member preferably exhibits a certain resistance against mechanical stress, such as abrasion. Thus, the material, or at least the surface of the member exhibits a sufficient hardness, and in a preferred execution, the flexible member is made with or from metallic material, such as—without limitation—iron, steel, aluminum, or mixtures or composites thereof.

Generally, flexible members as being useful or and described in the WO'055 application are also useful as contact members in the apparatus according to the present invention. Thus, in a first execution, the contact member is a wire, which exhibits essentially constant cross-sectional dimensions over a large length, such as a simple iron wire, e.g. having e.g. a circular diameter of 2 mm and exhibiting a deflection of more than 1 mm when submitted to the flexibility test. Suitable wires may, of course, exhibit cross-sections of different shapes, such as elliptical, polygonal, star-like, crescent shaped and the like. Preferably, however, the wires have a shape such that a rounded surface can be positioned towards the gap. Within the present context, also tubes are considered as “hollow wires”.

In a further execution, the flexible element as contact member can be a tubular flexible element with circumferential ribs. This is further explained by considering a coil spring as a non-limiting example for such an element. The coil spring may be made from a type of steel having a modulus of elasticity which is lower than the one of the anvil core and/or the support ribs. However, the particular shape of the coil spring provides a much higher flexibility than the wire of the coil as such. Without wishing to be bound by the theory, it is believed that this is due to the following reasons. First, considering the arched structure of a wire turn, this may transmit the forces tangentially away, and some reversible deformation may deform for example a circular wire into a somewhat elliptic one when the compression occurs. Even further, neighbouring turns may move relative to each other. Thus, the system exhibits a particular robustness with regard to variability, as it can react differently for each and every consolidation region. This combined effect is believed to result in a significantly smoothed operation, and peak forces are buffered away.

Optionally, and particularly beneficial in the context of an ultra sonic energy source, the contact element and the anvil core, both of which may be executed as described in the above, may be separated by a damper element, which is more flexible or deformable than the contact element. The damper element may exhibit the required flexibility or elasticity isotropically or uni-directionally. The flexibility or elasticity may be reached by inherent material properties, or by structural features, similar to the ones as described herein below. Such a damper element may also be an elastic, a viscoelastic, a viscous, or an pseudoelastic element, and may comprise natural or synthetic rubber, rubber-like materials such as SBS, SIS, (block-)copolymers, EVA, nylon, or silicones, or thermoplastic elastomers, mastics, asphalt based or bituminous material. The damper element may comprise cellulose based materials, such as paper or wood materials, but it can also be made of metallic material exhibiting a property difference compare to the contact element and the first anvil core. The damper elements may comprise solid, foamed or sponge-like, fibrous or shim-type structures, and voids or interstices thereof may be filled with another material. The damper element may be a separate element positioned between the contact element and the support rib, or between the support rib and the anvil core. Also, the support rib may function as damper element.

It should be noted, that equivalent executions for such a damper element are included within the scope of the present invention, such as when the damper element is executed integrally with the support rib, or if the damper element comprises multiple individual sub-elements, each individually or jointly satisfying the above requirements.

In addition to the mechanical benefits of the described contact member, it is believed, that it further provides advantages at high process speeds and/or when operating at very small gap widths, as the curved upper surface and the open structure allow for a very smooth air flow.

In a particular embodiment the contact member is a flexible elongated tubular anvil element as can be constructed by using a helical or coil spring, i.e. a helically wound wire.

A helix is a three-dimensional curve that turns around an axis at a constant or continuously varying distance while moving parallel to the axis., such as well known coil spring, i.e. a spring which can be made by winding a wire around a cylinder. Generally, such helical springs can be made and used as compression springs which are designed to become shorter when compressed along their length direction. Their turns (loops) are not touching in the unloaded position. Tension or extension springs are designed to become longer under a pull force along their length direction. Adjacent wire turns (loops) are normally touching each other in the unloaded position. Such a helically wound wire is defined by the inner and outer diameter of the helix (or coil), the form of the wire, the diameter of the wire (particularly when the wire has a circular cross section), the pitch (i.e. the distance of the centre points of adjacent wire turns), the canting angle (i.e. how much the connecting line of two adjacently opposed wire cross-section centre points is inclined versus the axis), and the hardness, stiffness and composition of the wire material, particularly at its outer surface. Typically, such helical elements show a circular cross section, but non circular cross sections such as e.g. elliptical ones may be desirable for particular applications. This also applies to the wire forming the helix, which may have a circular, a elliptical, or segmented cross-section, i.e. a circular or elliptical cross-section of which one or more segments are removed—either at the top surface (i.e. oriented towards the web(s)), and/or at one or both sides (i.e. oriented towards neighbouring wires).

Considering such a primary or first order structure of a straight helical anvil in Cartesian coordinates, the length or x-axis corresponds to the helix axis, whilst the y-direction is considered as width direction and the z-direction of thickness or height. Preferably, neighbouring wires forming the helix are displaceably contacting each other. Preferably the wire has a rounded wire cross-section, more preferably elliptical, most a preferably circular one. Alternatively, a part of the surface may be flattened, such as by being filed off, or the wire may have an oval or half-oval cross-section. Typically, the wire is solid, but provided the required mechanical properties are met, it can also be executed as a hollow tubular wire, optionally further comprising a core material. A wire may actually also be formed in the form of a helix (i.e. a “zero order helix”), optionally being wound around a flexible core, such as a hexagonal core. Any of the helical structures may be right- or left-handed.

A further particular structure is a helix which has been stretched along its x-direction, and in the extreme forms a two dimensional wave like structure, such as a sinus-curve shaped, or even a zig-zag shaped structure.

Optionally the flexible elongated member can be made from a primary helical anvil structure formed by a secondary helical anvil structure, e.g. when a long circular spring is wound around an anvil drum. Adjacent primary structure elements may be contacting each other or even interfere with each other, such that effectively the total anvil drum surface may be covered by the primary helical structure, or they may be spaced apart from each other. Such a set up can be very advantageously used for example when a wide web is to be consolidated over its entire surface, e.g. to form a nonwoven web. In a further particular execution, two or more helices (respectively parts of one helix, which may be wound around a cylinder) may be positioned adjacently to each other in a staggered or engaging or interdigitating arrangement.

A further particular execution of helical anvil structure is a litz wire, illustrating the broad range of helical materials with regard to size of bonding points as resulting from small diameter strands, also with regard to a high area density of bonding points as may result from the high number of strands, and a high flexibility as being a typical characteristic of litz wires.

After having described particular executions for the flexible elongated member the following will again refer to particular executions as may be optional or preferable for the flexible elongated member as such.

Preferably the flexible elongated member is made of metal, although other materials satisfying the mechanical and inertia requirements and exhibiting appropriate thermal conductivity may be equivalently employed.

The flexible elongated member can have a straight axis. Alternatively, such as when the anvil is mounted on a drum like anvil support, the anvil axis may have the form of a circle on the surface of the anvil support. Also, the axis may be curvilinearly shaped in any dimension, such as when a spring is bent.

The skilled person will readily realize that the geometry of the flexible elongated member determines the geometry of the consolidation regions. Whilst no one to one translation of the dimensions will be possible, for example the wire gauge of a helical anvil having its axis predominantly along the longitudinal direction of the web will correspond primarily to the x-directional extension of a consolidation region, whilst the helix diameter determines primarily the y-directional extension.

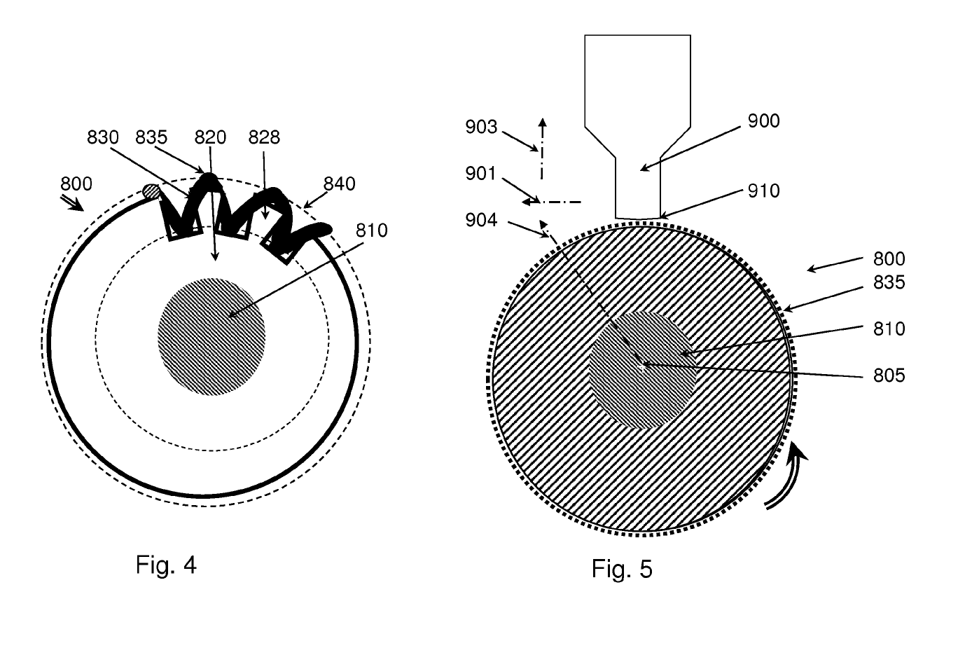

An apparatus according to the present invention is schematically depicted in FIG. 5. Therein a first anvil 800 comprises a first anvil core 810, here shown of cylindrical shape, although it may have other cross-sectional shapes, having its axis aligned with the first anvil axis 805, at least one first anvil support rib 820, extending from said first anvil core r-directionally outwardly as well as preferably predominantly circumferentially, and at least one contact member for contacting said webs in said gap with outer portions, here indicated as rounded dots 835. Such an anvil roll may have a diameter significantly larger than the key cross-sectional dimension of the contact member, as may be a flexible elongated member, often more than 5 times, or even more than 10 times thereof. In this execution, there may be a single flexible elongated member around the circumference of the anvil roll, or several ones. The flexible elongated member may be in the form of a circle perpendicular to the axis of the anvil roll or at an angle thereto. It may also have an irregular curvilinear form on the surface, which may be a closed loop. A flexible elongated member may also intersect another one, such as when one is positioned around a drum like support and another shorter struts-like member intersects such that a y-, +− or x-like crossing is created. Accordingly, a single member may comprise such crossings, or other members may be positioned without intersecting the first. Alternatively, the flexible elongated member may only be present on certain segments of the anvil roll, and missing in others.

The first anvil 800 rotates around its axis 805 and interacts with the second anvil 900 with an gap adjustment means (not shown), as may be integral with the second anvil, as may be an energy supplying sonotrode, thereby forming the gap 910in which a web (not shown) is consolidated. The gap width defines the z-direction 903 of the web, the general direction of the movement of the web and the overall machine direction or x-direction is indicated by 901, whilst the cross-machine direction is perpendicular to the two. The first anvil further exhibits a radial direction 904 away from its axis 805

The process for operating an apparatus according to the present invention follows the description as laid out in the above referenced WO'055 application, to which express reference is made, also with regard to the forming of the consolidation regions as such and in a linear arrangement or in two-dimensional patterns.

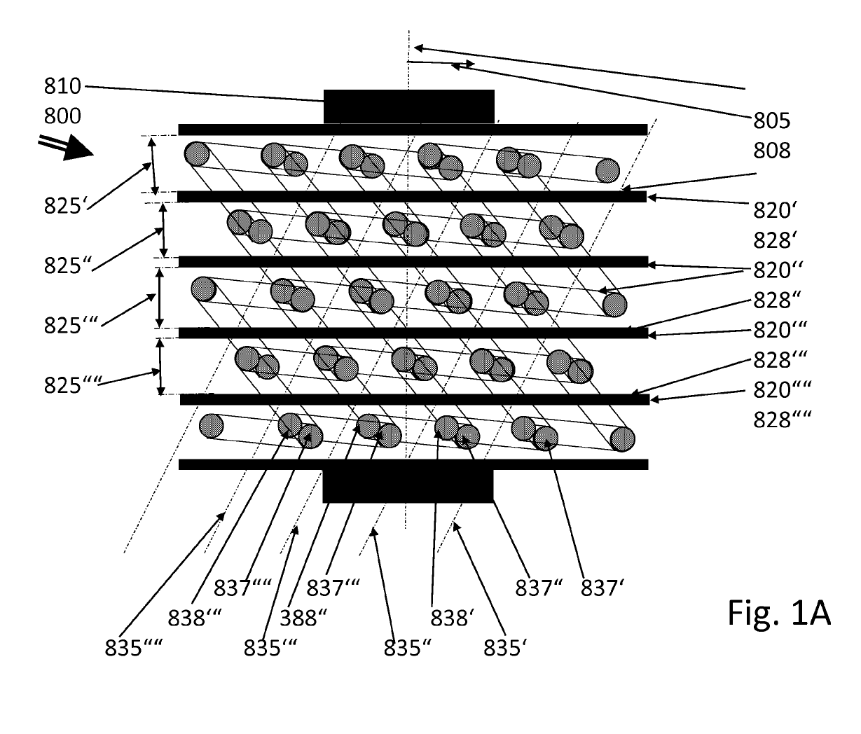

Without wishing to limit the invention to such an execution, the principle is explained by referring to schematic FIG. 1A and 1B (showing this only for a portion of the circumference). Therein is shown a first anvil 800 according to the present invention with a first anvil axis 805 and a radial direction as indicated as 808. A cylindrical first anvil core 810 is co-aligned with the first anvil axis. Circumferential support ribs 820′, 820″, 820′″, . . . extend radially outwardly from the first anvil core 810. The ribs are laterally spaced apart at a distance 825. The support ribs exhibit distal ends 828′, 828″, 828′″, . . . . The contact member is formed by a set of parallel and engaging helical springs 830′, 830″, 830′″, . . . with helix axes 835′, 835″, 835′″, . . . . The helical springs are shown out of plane in a cross-sectional view with cross-sections 837′, 837″, 837″, . . . belonging to the same winding as cross-sections 838′, 828″, 838′″ half a turn apart.

As shown for two thereof in FIG. 1B, the springs are placed relative to a support rib 820″ such that one winding 831′ and 831″ (further indicated by out of plane cross-sections 832′ and 832″) is on the side of the support rib 820″ towards the viewer and extending into the distance between two neighbouring support ribs, a neighbouring winding on the opposite side of the support rib (not shown), also extending into the respective neighbouring distance between the neighbouring support rib, whilst an outwardly positioned portion 835′ and 835″ arches over the distal end 828″ of the support rib 820″. Thus apexes 836′ and 836″ depict the most outwardly positioned point of the contact member, reaching into the gap between the first and the second anvil (neither shown), whilst the further portions 839′ and 839″ extend radially downwardly towards the first anvil axis 805. The circle 840 indicates the envelope circle for all apexes.

The support ribs as shown in a circumferential positioning may have other orientation, preferably predominantly circumferentially. They may also be in a form of a helix, such as in analogy of a cable reel drum. They may also be support blocks on top of the support ribs (see new figure). As indicated, the support rib may exhibit a rectangular cross-section at the distal end. Thus the contact members are supported by the support ribs at the corner points of the rectangular distal end and the outward portion arches over these contact points, as indicated by the arch openings 850′ and 850″. Upon r-directional forces, the contact member can deform in the outward region forming the arch and transmits the forces to the support rib. In comparison to the structures as depicted in the WO'055 application, this allows a different property window for the contact members, as the deformation is over a smaller part of a winding rather than over a full winding of the helical member.

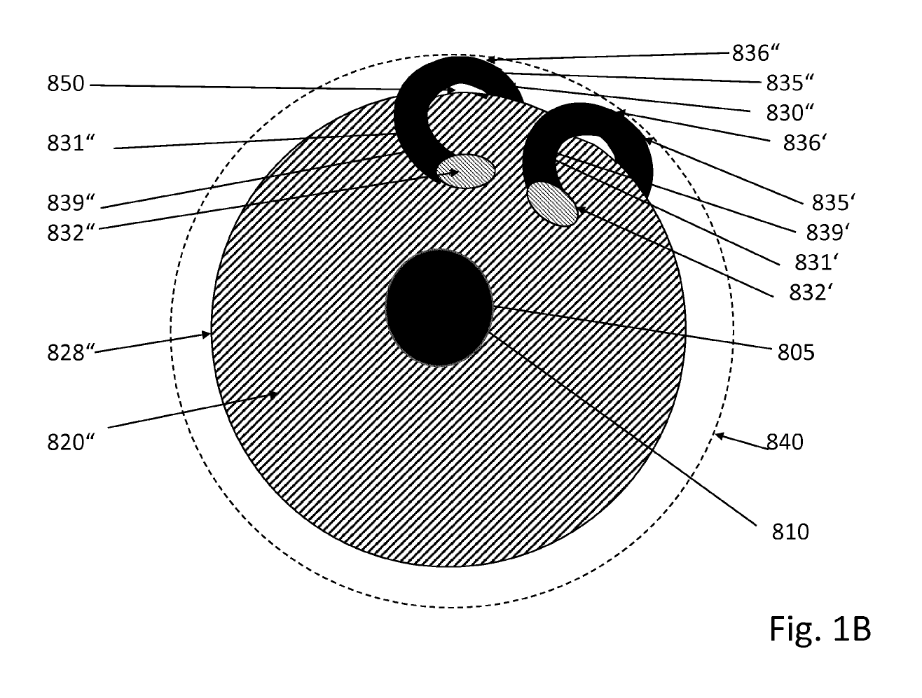

In a further execution, the radially inward portions of a helical contact element may run through sufficiently sized openings in the support ribs, such that they rest on the proximal end of a support rib and run through apertures of the neighbouring support ribs. Such a design becomes particularly simple, if the helix is stretched to its extreme and wires 830 (only one shown) run in a zig-zag path through holes 860 and over distal end 820 of the support ribs as indicated in FIGS. 2A and 2B (showing this only for a portion of the circumference). The skilled reader will readily realize that in case of the y-directional width of the ribs, the contact member may actually follow flat shape of the distal end of the rib, curved only be the outer radius of the support ribs. Such a design will the result in elongated bond points with rounded ends.

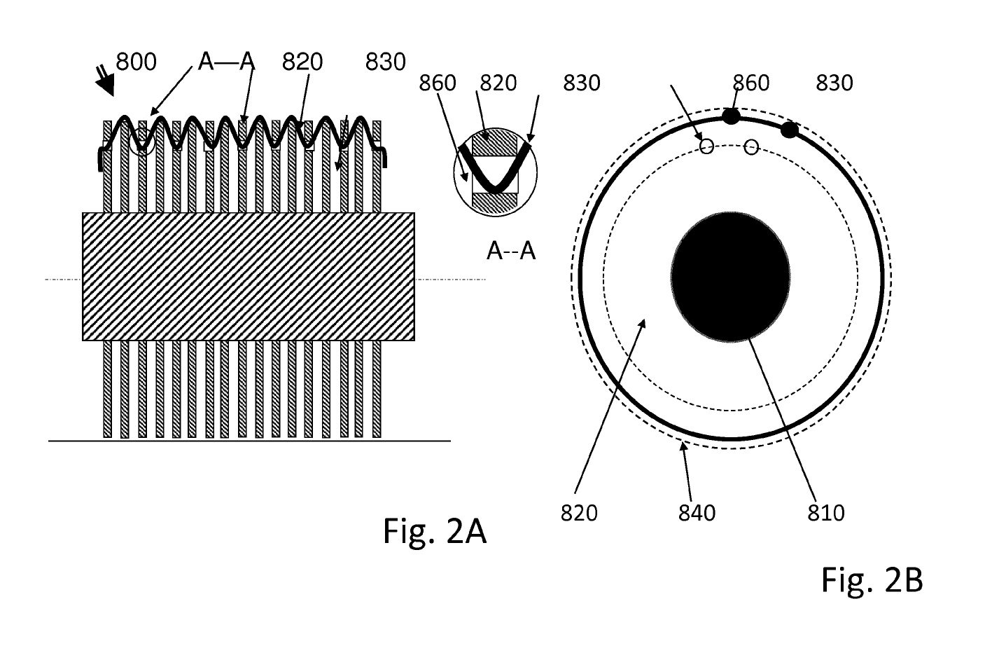

In yet another explanatory description as shown in FIG. 3A and 3B (showing this only for a portion of the circumference), there may be a number of contact members each in the form of a ring positioned such that the outward portion 835 of the ring rests on or is positioned just slightly above the distal ends 828 of the support ribs 820, whilst the other portions 831 of the ring are oriented towards the core of the first anvil. These other portions may fit with some clearance into matching openings 860 in the support ribs, whereby the clearance is adapted to allow some movement due to the flexing of the outwardly oriented arch of the ring. Upon contacting the second anvil, this embodiment allows two mechanisms of operation: In a first one, the other portion 831 is sufficiently fixed to allow transfer of the deformation forces from the outward portion 835 towards the other portion, as may rest in the opening 860, and then to the support rib 820. For this execution, the r-directional dislocation of the outward portion is determined by the flexibility of the total contact member, here shown as a ring. For the second mechanism, the contact member rests on the distal end of the support ribs 820, and the further portion may move relatively freely. For this execution, the small arch of the outward portion over the distal ends of the support ribs 820 determines the dislocation of the outward portion. The ring may have a Circle-clip or E-clip shape, or circular, oval or ellipsoidal shaped rings; snap rings; split rings, etc. It needs, however, to be ensured that the outward portion of the contact member forms the rounded portion with the apex from which the surface gradually tapers inwardly towards the core of the first anvil.

It should be noted that the cross-sectional shape of the support ribs may show many variances with rounded edges, multigonal designs, indentations at its uppermost surface, etc..

If the distal end exhibits two distal peaks or and a radius larger than the arching structure, the arching structure as described in the above might simple be used. If the distal ends exhibit only one distal peak (such as with a radius smaller than the one of the arching structure) the contact member may comprise inwardly oriented features to establish the arching function. For example, in case of using rings, these may have a form as known in principle from E-rings, adapted to match the shape of the distal end of the support rib.

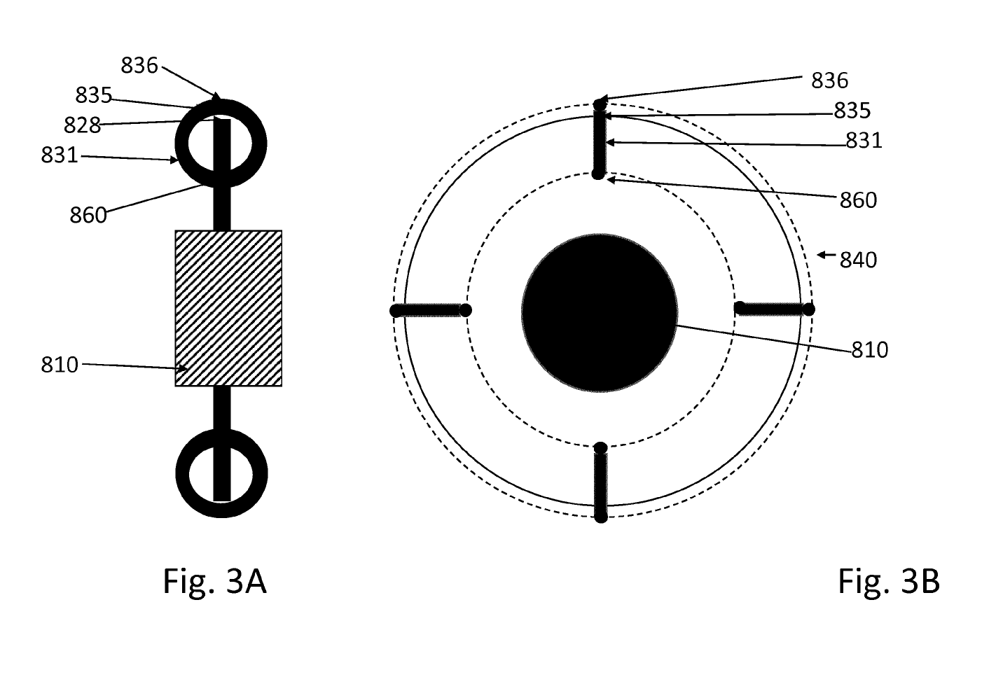

Yet a further approach to allow for the r-directional dislocation is depicted in FIG. 4 (showing this only for a portion of the circumference). Therein, the first anvil 800 comprises support ribs as may be created by providing cut outs or channels and a helical spring as contact member 830 is positioned with a portion of it inside the cut out or channel, and the outer portion arching over the distal ends 828 of the ribs 820. The cut-outs or channels can be of any size or shape accommodating the helical spring whilst providing a support for the spring on the further (or inward) portion of the spring. In such a set up, the outer portion of the spring not necessarily needs to contact the support ribs as long as no pressure is applied by the gap width adjustment.

Once such a pressure is applied, the outer portion deflects r-directionally and then contacts the distal ends of the support ribs.

Optionally, the r-directional dislocation of the outward portion of the contact member may be achieved by implementing damper elements, as described in the above. These may be positioned between the contact member and the support rib, e.g. in the arching space 850 as indicated in FIG. 1B. It may also be positioned between the anvil core and the support ribs, or the support ribs may exhibit damping properties.

The present invention is particular useful by allowing lower tolerance flexible members. For a smooth operation of the process, it is desirable to have small runout tolerances, i.e. the distance from the axis should preferably be the same for all tips of the flexible members, i.e.

the actual distance of the individual apexes of the outward portions of the contact member should in an unloaded operation deviate minimally from the ideal enveloping circle. In case of a helical flexible member, these tolerances are primarily impacted by the variations of the helix wire as such as well as by the variations of the winding of the helix, and by the present design the impact of such variations can be minimized. Preferably the total runout variation is less than 2 mm, preferably less than 0.2 mm, more preferably less than 20 μm and most preferably less than 2 _{R}m.

It should be noted that these tolerances apply to the flexible members forming one particular linear or two-dimensional pattern on one anvil roll, i.e. if an anvil roll carries several flexible members for forming two or more of such pattern, the tolerances apply to each one of these flexile members.

1. An apparatus for for consolidating one or more region(s) of one or more web(s), which comprise(s) thermoplastic material and which exhibit a length (x-), width (y-) and thickness (z-) direction, by plastic deformation,
said apparatus exhibiting a x- or machine direction aligned with the direction of movement of said web(s) relative to said apparatus, a y- or cross-machine direction aligned with the width direction of the web(s),
said apparatus comprising
one or more energy source(s) for increasing the temperature at least of said region(s) of said web(s);
a first and a second anvil formning a gap and adapted to receive said web(s) therein such that the thickness or z-direction of said webs is aligned with the gap width;
a gap width adjustment means adapted to apply pressure to said web(s) in said gap, wherein
said first anvil is rotatably mounted around a cross-machine direction oriented first anvil axis, further exhibiting a radial r-orientation away from said first anvil axis;
said first anvil comprising
i) a first anvil core having its axis aligned with said first anvil axis;
ii) at least one first anvil support rib, extending from said first anvil core r-directionally outwardly as well as preferably predominantly circumferentially,
iii) at least one contact member for contacting said webs in said gap wherein said contact member comprises
iv) a rounded non-spherical outward portion
v) that is positioned radially outwardly of and arching over a first anvil support rib and
extends into said gap and
being adapted for a r-directional dislocation upon the application of a pressure by said gap width adjustment means and
vi) at least one further portion of said contact member extends radially downwardly towards said first anvil axis.

2. An apparatus according to claim 1, wherein said r-directional dislocation of said outward portion of said contact member is achieved by means selected from the group consisting of,
a) two support points at the distal ends of said support ribs, over which said rounded outward portion of said contact member arches;
b) said contact means being supported by said further portions whilst said outward portions are adapted to not be in direct contact with said support ribs when no pressure is applied by said gap adjustment means, but to contact said support ribs when pressure is applied by said gap adjustment means;
c) a damper element positioned between said support rib and said contact member or said anvil core;
d) said support ribs exhibiting damper element properties.

3. An apparatus according to claim 1 or 2, wherein said contact member of said first anvil is selected from the group consisting of a wire, a helical spring preferably exhibiting a is circular, elliptical, flattened spherical, or hexagonal cross-section, a litz: wire, a rounded ring, preferably a circular, elliptical, oval ring, split rings, an open ring, a C-ring, an E-Ring, and a half ring.

4. An apparatus according to claim 1 or 2, , wherein said rounded outward portions exhibit a runout of less than 2 mm, preferably less than 0.2 mm more preferably less than 20 μm.

5. An apparatus according to claim 1 or 2, wherein said energy source is ultrasonic energy provided by said second anvil.

6. An apparatus according to claim 5, wherein said ultrasonic energy source is a rotatable mounted sonotrode,

7. A method for creating a plurality of consolidation regions in one or more web(s),
said method comprising the steps of
a) providing an apparatus according to any of the preceding claims;
b) providing at least one web comprising thermoplastic material, said web exhibiting a x- or machine direction, a y- or cross-machine direction, and a z- or thickness direction;
b) forming a gap corresponding to the z-direction of said web(s) between said first anvil and said second anvil,
c) feeding said web to said gap;
d) applying a z-directional pressure to said web in said gap, corresponding to a r-directional pressure applied to said contact member of said first anvil, thereby allowing dislocating said rounded outwardly oriented surface of said contact member of said first anvil relative to the rib over which they are arching;
f) compressing said web(s) in a predetermined pattern in said gap, thusly creating said consolidation regions; wherein said outwardly oriented surface of said contact member of said first anvil is radially dislocated more than 1 μm, relative to said first anvil axis.

8. A method for creating a plurality of consilidation regions in one or more web(s) according to claim 7, said method further comprising the step of:
e) providing energy to induce a temperature increase in said web or in predetermined regions thereof.
